(19) United States
(12) Patent Application Publication
(10) Pub. No.: US 2023/0327167 A1
(43) Pub. Date: Oct. 12, 2023

(54) FUEL CELL STACK AND SENSING TERMINAL FOR FUEL CELL STACK

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP)

(73) Assignee: TOYOTA BOSHOKU KABUSHIKI KAISHA, Aichi-ken (JP)

(21) Appl. No.: 18/122,305

(22) Filed: Mar. 16, 2023

(30) Foreign Application Priority Data
Mar. 23, 2022 (JP) 2022-047123

(51) Int. Cl. H01M 8/2475; H01M 8/0206

(52) U.S. Cl. CPC H01M 8/2475; H01M 8/0206

(57) ABSTRACT

A fuel cell stack includes a stack main body including stacked single cells, and sensing terminals made of metal. Two surfaces facing each other in any adjacent two of the single cells are respectively defined as a first facing surface and a second facing surface. The first facing surface is a surface of the first separator of one of the two single cells. The second facing surface is a surface of the second separator of the other single cell. The first facing surface is provided with at least one first engagement portion. Each sensing terminal includes a base portion, an arm portion, and at least one second engagement portion that is engaged with the at least one first engagement portion of the first facing surface. The arm portion is in contact with the second facing surface while being elastically deformed toward the first facing surface.

### BACKGROUND

### 1. Field

The present disclosure relates to a fuel cell stack and a sensing terminal for a fuel cell stack.

### 2. Description of Related Art

Japanese Laid-Open Patent Publication No. 2019-9004 discloses a fuel cell module. The fuel cell module includes a stack body having stacked cells and connectors that are each mounted to one of the cells. The connectors measure cell voltages. Each cell includes a first separator, a second separator, an insulation frame, and a membrane electrode assembly. The first separator and the second separator hold the membrane electrode assembly (hereinafter, referred to as a power generating unit) in between. The insulation frame is provided between the first separator and the second separator to surround the power generating unit. The first separator includes a mounting portion, to which the connector is mounted, at an edge. The connector includes two projections, which hold the mounting portion in between from the opposite sides in the thickness direction of the first separator.

When mounting a connector, an operator inserts the mounting portion of the first separator into the space between the distal portions of the two projections, and then pushes the connector to a specified position.

In the case of the connector disclosed in the above publication, the operator needs to check whether the distal portions of the two projections are holding the mounting portion of the first separator in between. This complicates the mounting operation.

### SUMMARY

Accordingly, it is an objective of the present disclosure to provide a fuel cell stack and a sensing terminal for a fuel cell stack that facilitate mounting of a sensing terminal.

In a general aspect, a fuel cell stack includes a stack main body and sensing terminals made of metal. The stack main body includes stacked single cells. Each single cell includes a power generating unit, a first separator, and a second separator. The first separator and the second separator hold the power generating unit in between. Each sensing terminal is inserted into a space between the first separator of a corresponding one of the single cells and the second separator of another single cell that is adjacent to the corresponding single cell, from outside the single cells. Two surfaces facing each other in any adjacent two of the single cells are respectively defined as a first facing surface and a second facing surface. The first facing surface is a surface of the first separator of one of the two single cells, and the second facing surface is a surface of the second separator of the other single cell. The first facing surface is provided with at least one first engagement portion. Each sensing terminal includes a base portion, an arm portion, and at least one second engagement portion. The base portion contacts the first facing surface of the corresponding first separator. The arm portion protrudes from the base portion toward the second facing surface of the corresponding second separator and extends toward a trailing side in an insertion direction of the sensing terminal. The at least one second engagement portion is engaged with the at least one first engagement portion of the first facing surface by means of a recess-and-projection relationship to prevent the sensing terminal from coming off the stack main body. The arm portion is in contact with the second facing surface while being elastically deformed toward the first facing surface.

In another general aspect, a sensing terminal made of metal is configured to be used for a fuel cell stack. The fuel cell stack includes a stack main body that includes stacked single cells. Each single cell includes a power generating unit, a first separator, and a second separator. The first separator and the second separator hold the power generating unit in between. The sensing terminal is configured to be inserted into a space between the first separator of a corresponding one of the single cells and the second separator of another single cell that is adjacent to the corresponding single cell, from outside the single cells. Two surfaces facing each other in any adjacent two of the single cells are respectively defined as a first facing surface and a second facing surface. The first facing surface is a surface of the first separator of one of the two single cells, and the second facing surface is a surface of the second separator of the other single cell. The sensing terminal includes a base portion, an arm portion, and a received portion. The base portion contacts the first facing surface of the corresponding first separator. The arm portion protrudes from the base portion toward the second facing surface of the corresponding second separator and extends toward a trailing side in an insertion direction of the sensing terminal. The received portion is engaged with a receiving portion provided in the first facing surface by means of a recess-and-projection relationship to prevent the sensing terminal from coming off the stack main body. The arm portion is in contact with the second facing surface while being elastically deformed toward the first facing surface.

Other features and aspects will be apparent from the following detailed description, the drawings, and the claims.

### BRIEF DESCRIPTION OF THE DRAWINGS

FIG. 1 is an exploded perspective view of a fuel cell stack according to one embodiment, illustrating single cells and sensing terminals separated from each other.

FIG. 2 is an exploded perspective view of a single cell shown in FIG. 1.

FIG. 3 is a perspective view of a sensing terminal shown in FIG. 1.

FIG. 4 is a cross-sectional view taken along line 4-4 of FIG. 3.

FIG. 5 is a cross-sectional view taken along line 5-5 of FIG. 6.

FIG. 6 is a cross-sectional view taken along line 6-6 of FIG. 5.

FIGS. 7A to 7D are cross-sectional views showing procedures for mounting and demounting the sensing terminal.

FIG. 8 is a cross-sectional view corresponding to FIG. 5, illustrating a mounted state of a sensing terminal according to a first modification.

FIG. 9 is a cross-sectional view taken along line 9-9 of FIG. 8.

FIG. 10 is a cross-sectional view corresponding to FIG. 5, illustrating a mounted state of a sensing terminal according to a second modification.

FIG. 11 is a cross-sectional view taken along line A-A of FIG. 10.

FIG. 12 is a cross-sectional view corresponding to FIG. 5, illustrating a mounted state of a sensing terminal according to a third modification.

FIG. 13 is a cross-sectional view taken along line B-B of FIG. 12.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

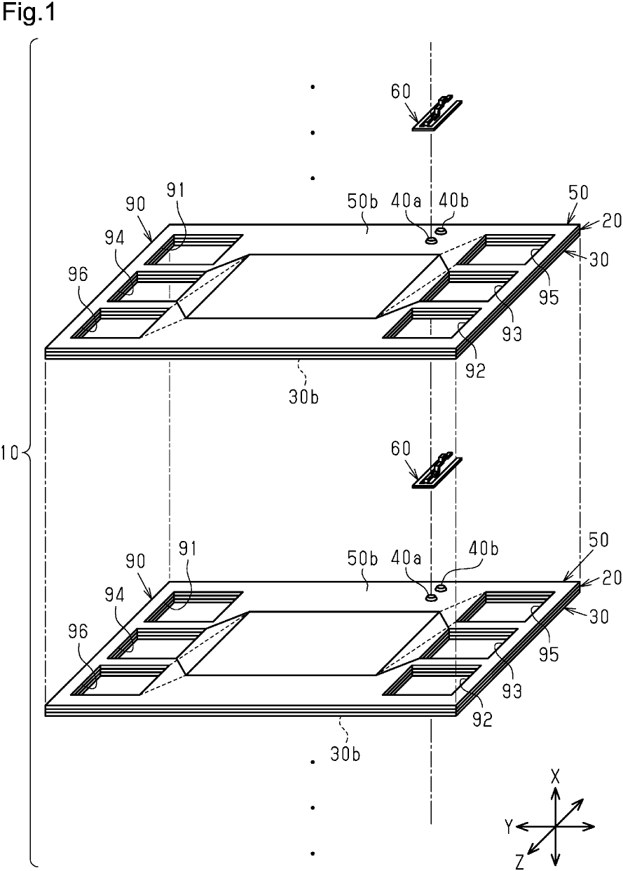

A fuel cell stack and a sensing terminal for a fuel cell stack according to one embodiment will be described with reference to FIGS. 1 to 7D.

For illustrative purposes, some parts of the structures in the drawings are exaggerated or simplified, and the dimensional ratios of the structures may be different from the actual ratios.

As shown in FIG. 1, the fuel cell stack includes a stack main body 10 and sensing terminals 60 made of metal. The stack main body 10 includes stacked single cells 90.

First, the single cell 90 will be described.

### <Single Cell 90>

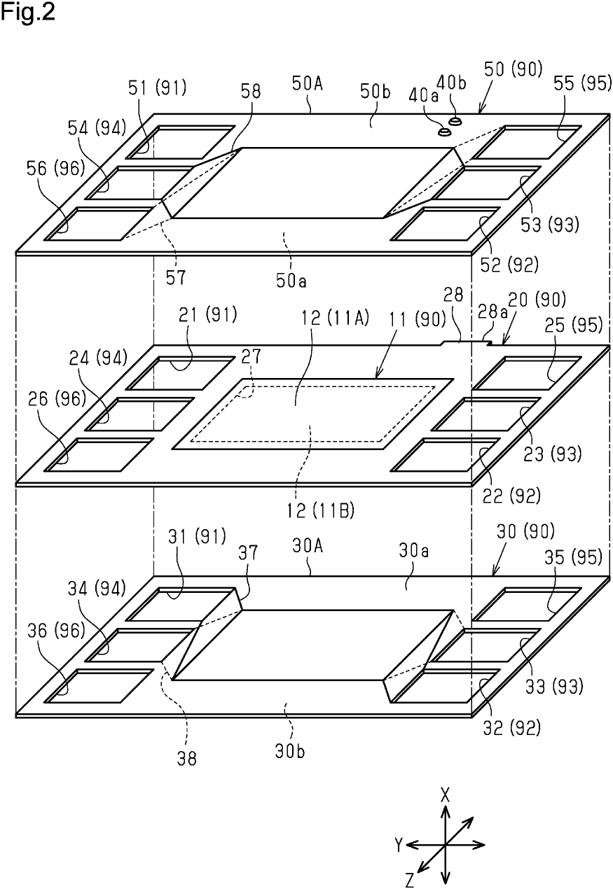

As shown in FIG. 2, the single cell 90 includes a membrane electrode assembly (MEA) 11 (hereinafter, referred to as a power generating unit 11), a sheet member 20, which has an electrical insulation property and surrounds the power generating unit 11, a cathode-side separator 50, and an anode-side separator 30. The cathode-side separator 50 and the anode-side separator 30 hold the power generating unit 11 and the sheet member 20 in between.

The single cell 90 is a rectangular plate as a whole.

In the following description, the direction in which the anode-side separator 30, the power generating unit 11 and the sheet member 20, and the cathode-side separator 50 are stacked, and the direction in which the single cells 90 are stacked will be referred to as a first direction X.

Also, the directions in which the long sides and the short sides of the single cells 90 extend will be respectively referred to as a second direction Y and a third direction Z. The first direction X, the second direction Y, and the third direction Z form a Cartesian coordinate system.

The single cell 90 includes inlet holes 91, 93, 95 for introducing fuel gas, cooling medium, and oxidant gas into the single cell 90, and outlet holes 92, 94, 96 for discharging the fuel gas, the cooling medium, and the oxidant gas to the outside from inside the single cell 90.

The inlet holes 91, 93, 95 and the outlet holes 92, 94, 96 extend in the first direction X through the single cell 90. The inlet hole 91 and the outlet holes 94, 96 are located at a first end in the second direction Y of the single cell 90 (at the left end in the left-right direction in FIG. 1). The inlet hole 91 and the outlet holes 94, 96 are arranged in that order in the third direction Z while being spaced apart from each other. The outlet hole 92 and the inlet holes 93, 95 are located at a second end in the second direction Y of the single cell 90 (at the right end in FIG. 1). The outlet hole 92 and the inlet holes 93, 95 are arranged in that order in the third direction Z while being spaced apart from each other.

### Power Generating Unit 11

As shown in FIG. 2, the power generating unit 11 includes a solid polymer electrolyte membrane (not shown; hereinafter referred to as an electrolyte membrane) and electrodes 11A, 11B respectively provided on opposite surfaces of the electrolyte membrane. In the present embodiment, the electrode that is joined to the surface on a first side in the first direction X (the upper side in the up-down direction in FIG. 1) of the electrolyte membrane (not shown) is a cathode 11A. Also, the electrode joined to the surface on a second side in the first direction X (the lower side in the in FIG. 1) of the electrolyte membrane is an anode 11B.

The electrodes 11A, 11B each include a catalyst layer (not shown) joined to the electrolyte membrane and a gas diffusion layer 12 (hereinafter referred to as a GDL 12), which is joined to the catalyst layer.

### <Sheet Member 20>

As shown in FIG. 2, the sheet member 20 is provided between the cathode-side separator 50 and the anode-side separator 30, which are components of the single cell 90. The sheet member 20 is a substantially rectangular plate elongated in the second direction Y. The sheet member 20 is made of a plastic having an electrical insulation property.

The sheet member 20 includes through-holes 21, 22, 23, 24, 25, 26, which are respectively parts of the holes 91, 92, 93, 94, 95, 96.

The sheet member 20 includes an opening 27 at a center. The periphery of the power generating unit 11 is joined to the inner peripheral edge of the opening 27 from the first side in the first direction X (upper side in FIG. 1).

### <Cathode-Side Separator 50>

As shown in FIG. 2, the cathode-side separator 50 is a rectangular plate elongated in the second direction Y.

The cathode-side separator 50 is formed by pressing, for example, a metal thin plate made of titanium or stainless steel.

The cathode-side separator 50 is provided on the side of the power generating unit 11 on which the cathode 11A is provided.

The cathode-side separator 50 includes a holding surface 50a and a first facing surface 50b. The holding surface 50a faces the power generating unit 11. The first facing surface 50b is a surface on the side opposite to the holding surface 50a and faces the anode-side separator 30 of the adjacent single cell 90.

The cathode-side separator 50 includes through-holes 51, 52, 53, 54, 55, 56, which are respectively parts of the holes 91, 92, 93, 94, 95, 96.

As shown in FIG. 2, the cathode-side separator 50 includes groove passages 57 through which oxidant gas flows and groove passages 58 through which cooling medium flows. The groove passages 57 are provided in the holding surface 50a. The groove passages 58 are provided in the first facing surface 50b. FIG. 2 illustrates, in a simplified manner, the outer edge of a section in the cathode-side separator 50 that includes the groove passages 57 and the outer edge of a section in the cathode-side separator 50 that includes the groove passages 58.

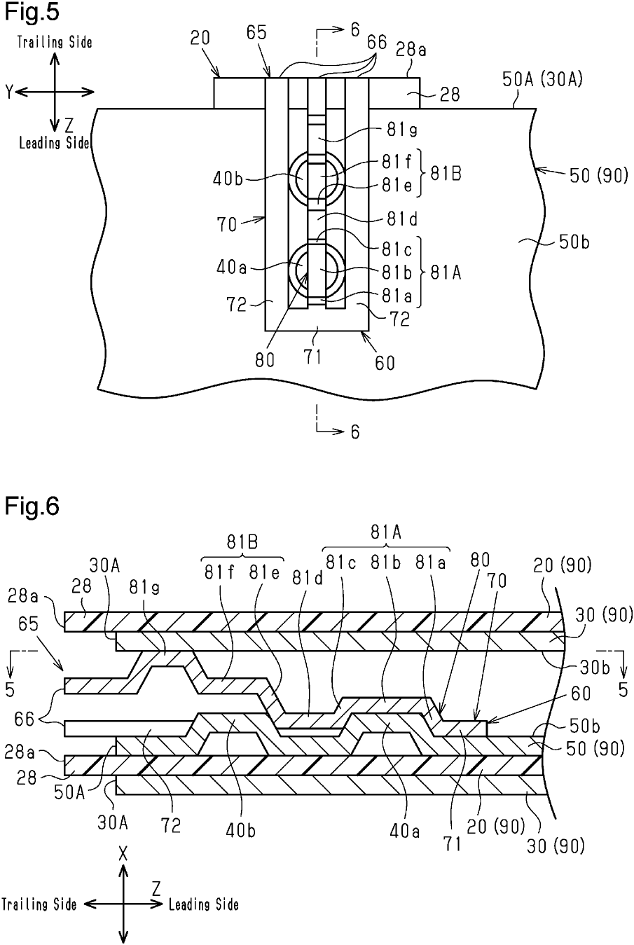

As shown in FIGS. 2 and 5, the first facing surface 50b is provided with first engagement portions 40a, 40b. The first engagement portions 40a, 40b are provided, for example, between the through-hole 51 and the through-hole 55 in the second direction Y. The first engagement portions 40a, 40b in the present embodiment are located closer to the through-hole 51 than to the through-hole 55 in the second direction Y.

The first engagement portions 40a, 40b provided on a single cell 90 protrude in the first direction X toward a second facing surface 30b of an adjacent single cell 90.

The first engagement portions 40a, 40b in the present embodiment each have a truncated conical shape.

The first engagement portions 40a, 40b are spaced apart from each other in the third direction Z.

The cathode-side separator 50 corresponds to the first separator according to the present disclosure.

### Anode-Side Separator 30

As shown in FIG. 2, the anode-side separator 30 is a rectangular plate elongated in the second direction Y.

The anode-side separator 30 is formed by pressing, for example, a metal thin plate made of titanium or stainless steel.

The anode-side separator 30 is provided on the side of the power generating unit 11 on which the anode 11B is provided.

The anode-side separator 30 includes a holding surface 30a and a second facing surface 30b. The holding surface 30a faces the power generating unit 11. The second facing surface 30b is a surface on the side opposite to the holding surface 30a and faces the cathode-side separator 50 of the adjacent single cell 90.

The anode-side separator 30 includes through-holes 31, 32, 33, 34, 35, 36, which are respectively parts of the holes 91, 92, 93, 94, 95, 96.

As shown in FIG. 2, the anode-side separator 30 includes groove passages 37 through which fuel gas flows and groove passages 38 through which cooling medium flows. The groove passages 37 are provided in the holding surface 30a. The groove passages 38 are provided in the second facing surface 30b. FIG. 2 illustrates, in a simplified manner, the outer edge of a section in the anode-side separator 30 that includes the groove passages 37 and the outer edge of a section in the anode-side separator 30 that includes the groove passages 38.

The anode-side separator 30 corresponds to the second separator according to the present disclosure.

### Sensing Terminal 60

As shown in FIG. 1, the sensing terminals 60 are respectively provided on the opposite sides in the first direction X of each single cell 90. Each sensing terminal 60 is formed by pressing a metal plate. The metal plate is preferably made of titanium, stainless steel, aluminum, or copper.

As shown in FIGS. 5 and 6, the sensing terminal 60 is inserted into a space between the cathode-side separator 50 of one single cell 90 and the anode-side separator 30 of an adjacent single cell 90 from outside the single cells 90. In the present embodiment, the sensing terminal 60 is inserted in the third direction Z.

In the following description, the leading side and the trailing side in the insertion direction of the sensing terminal 60 will be simply referred to as the leading side and the trailing side.

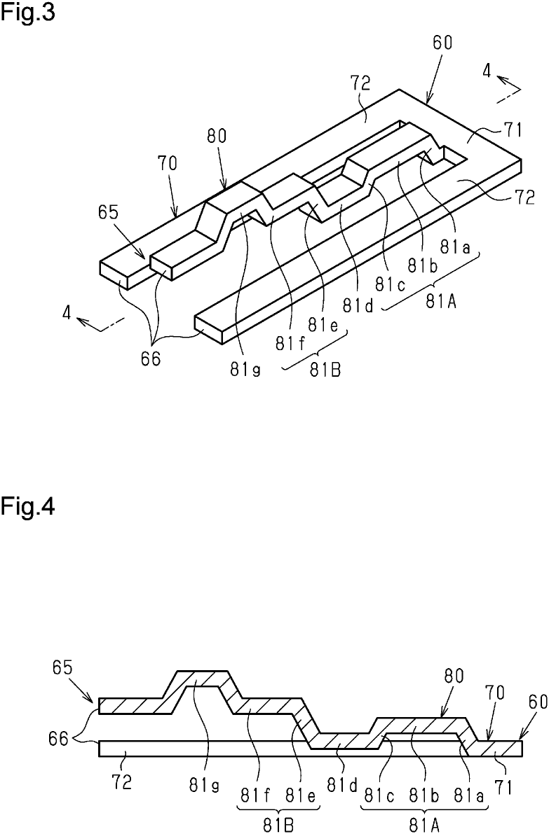

As shown in FIGS. 3 and 4, the sensing terminal 60 includes a base portion 70, an arm portion 80, and second engagement portions 81A, 81B.

The base portion 70 includes a coupling portion 71 and two extending portions 72. The coupling portion 71 extends in the second direction Y. The two extending portions 72 extend toward the trailing side from the opposite ends in the second direction Y of the coupling portion 71. The coupling portion 71 and the two extending portions 72 each have the shape of a flat plate extending in planar directions of the single cell 90.

As shown in FIGS. 5 and 6, the base portion 70 is in contact with the first facing surface 50b. The two extending portions 72 hold the two first engagement portions 40a, 40b in between in the second direction Y.

The arm portion 80 protrudes from the base portion 70 toward the second facing surface 30b and extends toward the trailing side.

The arm portion 80 is coupled to a central portion of the coupling portion 71 in the second direction Y.

The arm portion 80 includes a first inclined section 81a, a first flat section 81b, a second inclined section 81c, a second flat section 81d, a third inclined section 81e, a third flat section 81f, and a protruding section 81g in that order from the leading side.

The first inclined section 81a is inclined such that the distance between the first inclined section 81a and the second facing surface 30b in the first direction X decreases toward the trailing side.

The first flat section 81b extends in the third direction Z from the trailing end of the first inclined section 81a toward the trailing side.

The second inclined section 81c is inclined such that the distance between the second inclined section 81c and the second facing surface 30b in the first direction X increases toward the trailing side.

The second flat section 81d extends from the trailing end of the second inclined section 81c toward the trailing side in the third direction Z.

The third inclined section 81e is inclined such that the distance between the third inclined section 81e and the second facing surface 30b in the first direction X decreases toward the trailing side.

The third flat section 81f extends in the third direction Z from the trailing end of the third inclined section 81e toward the trailing side.

The second flat section 81d, the first flat section 81b, and the third flat section 81f are spaced apart from the second facing surface 30b in the first direction X. The distance to the second facing surface 30b increases in the order of the second flat section 81d, the first flat section 81b, and the third flat section 81f.

The protruding section 81g protrudes toward the second facing surface 30b from a central portion of the third flat section 81f in the third direction Z.

The first inclined section 81a, the first flat section 81b, and the second inclined section 81c form the second engagement portion 81A, which is engaged with the first engagement portion 40a on the leading side by means of a recess-and-projection relationship.

The third inclined section 81e and the third flat section 81f form the second engagement portion 81B, which is engaged with the first engagement portion 40b on the trailing side by means of a recess-and-projection relationship.

The second engagement portions 81A, 81B are provided to correspond to the two first engagement portions 40a, 40b.

The protruding section 81g is in contact with the second facing surface 30b with the arm portion 80 elastically deformed toward the first facing surface 50b.

The sensing terminal 60 includes a protruding portion 65, which protrudes further outward from respective edges 50A, 30A of the cathode-side separator 50 and the anode-side separator 30. The protruding portion 65 is formed by the distal ends of the two extending portions 72 of the base portion 70 and the distal end of the third flat section 81f of the arm portion 80. The base portion 70 and the arm portion 80 protrude outward from the single cell 90.

As shown in FIGS. 2 and 5, the sheet member 20 includes a cover portion 28, which covers the protruding portion 65 in the first direction X. The cover portion 28 protrudes outward from an edge of the sheet member 20. The cover portion 28 is provided over the entire protruding portion 65 in the second direction Y. The length of the cover portion 28 in the second direction Y in the present embodiment is greater than the length of the protruding portion 65 in the second direction Y.

The protruding portion 65 is provided with marks 66 at positions of a protruding end 28a of the cover portion 28 in the third direction Z, that is, in the insertion direction. The marks 66 indicate that the sensing terminal 60 has been inserted to a proper position.

As shown in FIGS. 5 and 6, in the present embodiment, the protruding end 28a of the cover portion 28 is aligned with the protruding end of the protruding portion 65 of the sensing terminal 60 in the first direction X.

In the present embodiment, the marks 66 are the protruding end of the protruding portion 65.

Next, procedures for mounting and demounting the sensing terminal 60 of the present embodiment will be described.

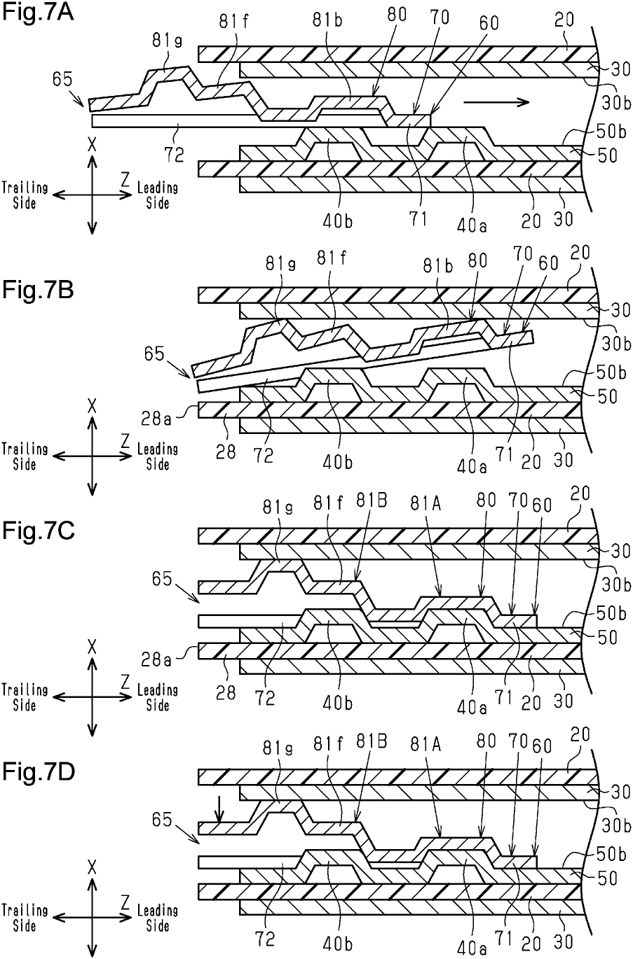

When mounting the sensing terminal 60, the operator holds the distal ends of the two extending portions 72 and the distal end of the third flat section 81f of the arm portion 80 with their fingers, and presses the arm portion 80 so that the distal ends approach each other, thereby elastically deforming the arm portion 80, as shown in FIG. 7A. The operator inserts the sensing terminal 60 in this state into the space between the anode-side separator 30 and the cathode-side separator 50 with the coupling portion 71 on the leading side.

Next, as illustrated in FIG. 7B, the operator inserts the sensing terminal 60 while sliding the first flat section 81b along the second facing surface 30b until the protruding end of the protruding portion 65 of the sensing terminal 60 is aligned with the protruding end 28a of the cover portion 28 in the first direction X.

When the operator releases their fingers from the sensing terminal 60, the elastically deformed arm portion 80 is restored to the original shape toward the second facing surface 30b as shown in FIG. 7C. This causes the base portion 70 to contact the first facing surface 50b, and the protruding section 81g of the arm portion 80 to contact the second facing surface 30b. Also, the second engagement portions 81A, 81B are engaged with the first engagement portions 40a, 40b by means of a recess-and-projection relationship. The mounting of the sensing terminal 60 is thus completed.

When demounting the sensing terminal 60, the operator holds the distal ends of the two extending portions 72 and the distal end of the third flat section 81f of the arm portion 80 with their fingers, and presses the arm portion 80 so that the distal ends approach each other, thereby elastically deforming the arm portion 80, as shown in FIG. 7D. Next, the operator pulls out the sensing terminal 60 in this state from between the anode-side separator 30 and the cathode-side separator 50 in the reverse order of the mounting procedure. The detachment of the sensing terminal 60 is thus completed.

Operation of the present embodiment will now be described.

As shown in FIG. 6, the sensing terminal 60 is inserted into the space between the cathode-side separator 50 and the anode-side separator 30 from outside the single cells 90. At this time, the arm portion 80 is elastically deformed toward the first facing surface 50b, so that the base portion 70 comes into contact with the first facing surface 50b, and the arm portion 80 comes into contact with the second facing surface 30b. Then, the second engagement portions 81A, 81B of the sensing terminal 60 are engaged with the first engagement portions 40a, 40b on the first facing surface 50b by means of a recess-and-projection relationship. Since the base portion 70 and the arm portion 80 are respectively urged toward the first facing surface 50b and the second facing surface 30b, the second engagement portions 81A, 81B and the first engagement portions 40a, 40b remain engaged with each other. This prevents the sensing terminal 60 from coming off the stack main body 10. Thus, the sensing terminal 60 is mounted simply by inserting the sensing terminal 60 into the space between the cathode-side separator 50 of one single cell 90 and the anode-side separator 30 of the adjacent single cell 90 from outside the single cells 90.

The present embodiment has the following advantages.

(1) The sensing terminal 60 includes the base portion 70, which is in contact with the first facing surface 50b, and the arm portion 80, which protrude from the base portion 70 toward the second facing surface 30b and extends toward the trailing side in the insertion direction of the sensing terminal 60. The sensing terminal 60 includes the second engagement portions 81A, 81B (receiving portions), which are engaged with the first engagement portions 40a, 40b (received portions) by means of a recess-and-projection relationship to prevent the sensing terminal 60 from coming off the stack main body 10. The arm portion 80 is in contact with the second facing surface 30b while being elastically deformed toward the first facing surface 50b.

This configuration operates in the above described manner and thus allows the sensing terminal 60 to be mounted in a facilitated manner.

(2) The first engagement portions 40a, 40b protrude toward the second facing surface 30b.

The first engagement portions 40a, 40b may be recesses that open to the first facing surface 50b. In this case, if the recesses are formed by pressing a metal thin plate, protrusions are formed on the surface of the cathode-side separator 50 that faces the sheet member 20. Since the protrusions interfere with the sheet member 20, it is necessary to take measures such as providing the sheet member 20 with recesses into which the protrusions escape.

Such inconvenience is not caused in the above-described configuration since the first engagement portions 40a, 40b protrude toward the second facing surface 30b.

(3) The first engagement portions 40a, 40b are spaced apart from each other in the insertion direction. The second engagement portions 81A, 81B are provided to correspond to the respective first engagement portions 40a, 40b.

For example, one first engagement portion and one second engagement portion, each of which has a circular cross-sectional shape, are provided, the sensing terminal 60 may rotate about the first engagement portion.

In this regard, the first engagement portions 40a, 40b of the above-described configuration are spaced apart from each other in the insertion direction. This prevents the sensing terminal 60 from rotating about the first engagement portions 40a, 40b. The position of the mounted sensing terminal 60 is thus stabilized.

(4) The base portion 70 and the arm portion 80 protrude outward from the single cell 90.

This configuration allows the operator to hold with fingers parts of the base portion 70 and the arm portion 80 that protrude outward from the single cell 90 when removing the sensing terminal 60 from the stack main body 10. In addition, the operator can elastically deform the arm portion 80 by pressing the arm portion 80 toward the base portion 70 while holding with fingers the protruding parts of the base portion 70 and the arm portion 80. This facilitates disengagement of the first engagement portions 40a, 40b and the second engagement portions 81A, 81B from each other. The sensing terminal 60 is smoothly removed from the stack main body 10 by pulling out the sensing terminal 60.

(5) The single cell 90 includes the sheet member 20, which is provided between the cathode-side separator 50 and the anode-side separator 30. The sheet member 20 surrounds the power generating unit 11 and has an electrical insulation property. The sensing terminals 60 are respectively provided on the opposite sides in the stacking direction of each single cell 90. The sensing terminal 60 includes a protruding portion 65, which protrudes further outward from respective edges 50A, 30A of the cathode-side separator 50 and the anode-side separator 30. The sheet member 20 includes the cover portion 28, which covers the protruding portion 65 in the stacking direction.

With this configuration, the protruding portions 65 of the sensing terminals 60 on the opposite sides of the single cell 90 are electrically insulated from each other by the cover portion 28 of the sheet member 20. This eliminates the necessity for a dedicated insulating member for electrically insulating the protruding portions 65 from each other.

(6) The protruding portion 65 is provided with the marks 66 at the position of the protruding end 28a of the cover portion 28 in the insertion direction. The marks 66 indicate that the sensing terminal 60 has been inserted to the proper position.

This configuration allows the operator to readily check whether the sensing terminal 60 has been inserted to the proper position by visually checking that the marks 66 provided on the protruding portion 65 of the sensing terminal 60 are located at the position of the protruding end 28a of the cover portion 28 in the insertion direction.

(7) The marks 66 are at the protruding end of the protruding portion 65.

With this configuration, since the protruding end of the protruding portion 65 of the sensing terminal 60 serves as the marks 66, the configuration of the sensing terminal 60 is simplified. This eliminates the necessity for additional marks on the protruding portion 65.

### Modifications

The above-described embodiment may be modified as follows. The above-described embodiment and the following modifications can be combined if the combined modifications remain technically consistent with each other.

The protruding portion 65 of the sensing terminal 60 may protrude outward from the protruding end 28a of the cover portion 28. In this case, the protruding portion 65 may be provided with a mark at the position of the protruding end 28a of the cover portion 28 in the third direction Z.

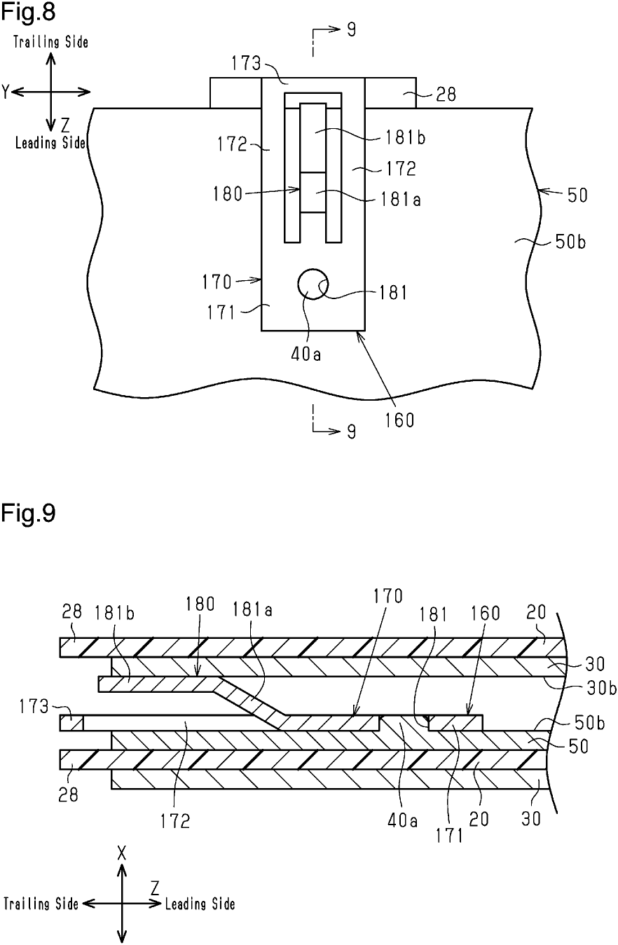

FIGS. 8 and 9 show a sensing terminal 160 according to a first modification. The sensing terminal 160 is different from the first embodiment in that a single second engagement portion 181 is provided in a base portion 170. In this case, the second engagement portion 181 is a through-hole that extends in the first direction X through a first coupling portion 171 of the base portion 170. Also, an arm portion 180 only includes an inclined section 181a and a flat section 181b. The flat section 181b is in contact with the second facing surface 30b. The base portion 170 includes a second coupling portion 173, which couples the distal ends of two extending portions 172 to each other.

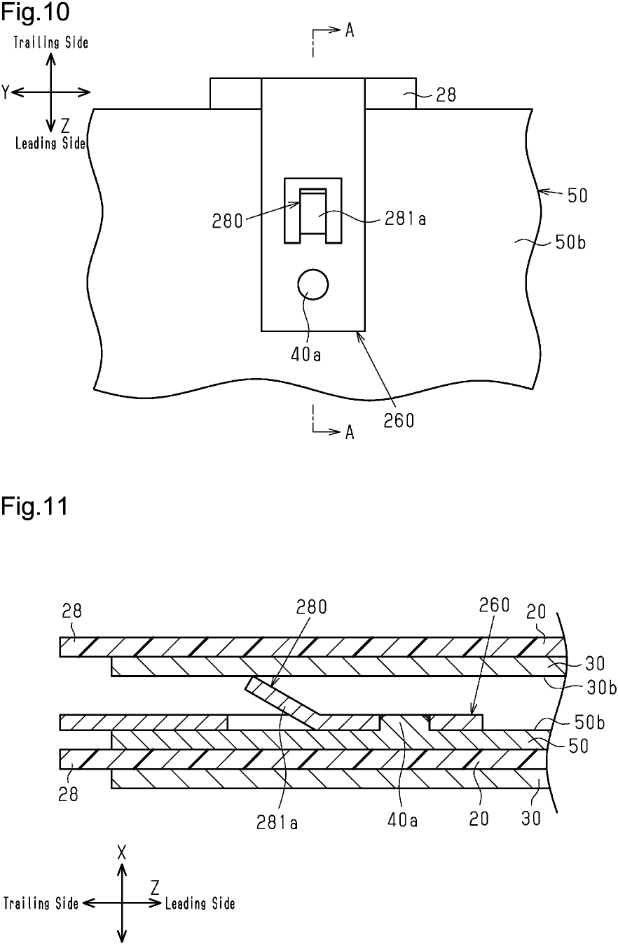

FIGS. 10 and 11 show a sensing terminal 260 according to a second modification. The sensing terminal 260 includes an arm portion 280, which includes only an inclined section 281a. The inclined section 281a is in contact with the second facing surface 30b.

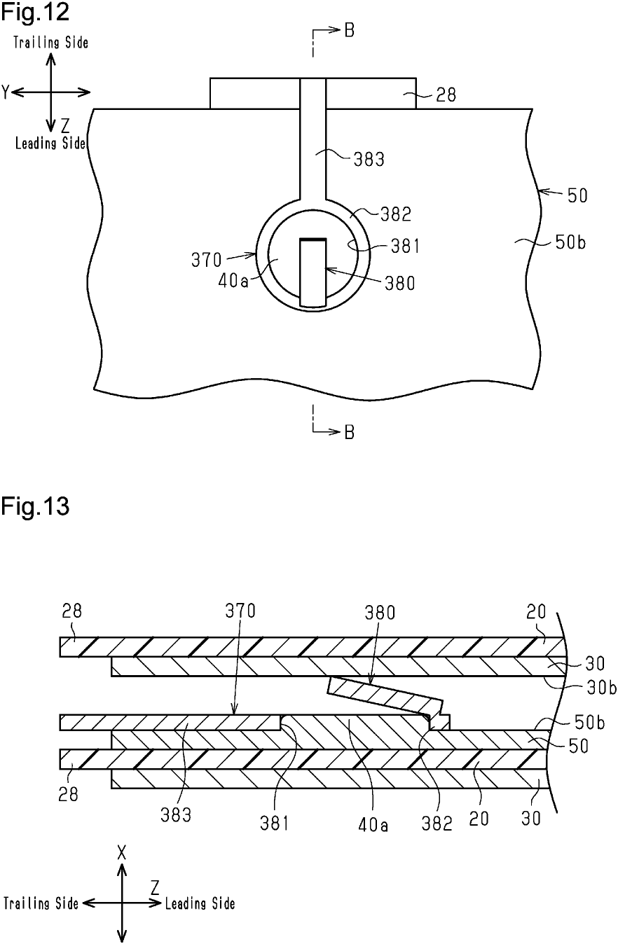

As shown in FIGS. 12 and 13, a base portion 370 may include an annular portion 382 and an extending portion 383, which extends from the annular portion 382 toward the trailing side. In this case, the hole of the annular portion 382 functions as a second engagement portion 381. Also, an arm portion 380 may protrude from a leading portion of the annular portion 382.

For example, the protruding portion 65 of the sensing terminal 60 may be provided with an insulating coating. In this case, the cover portion 28 can be omitted.

The sensing terminal 60 may be provided on one side in the first direction X of the single cell 90.

Three or more first engagement portions may be provided. In this case, the number of the second engagement portions may be changed in accordance with the number of the first engagement portions.

The first engagement portions 40a, 40b are not limited to having truncated conical shapes, which have a circular cross-sectional shape. The first engagement portions may have, for example, a rectangular or elliptic cross-sectional shape. In this case, if the number of the first engagement portions is one, the sensing terminal 60 is prevented from rotating about the first engagement portion.

The first engagement portions 40a, 40b may be recesses that open in the first facing surface 50b.

At least one of the anode-side separator 30 and the cathode-side separator 50 may be made of a carbon-containing plastic.

In the above-described embodiment and modifications, the first engagement portions 40a, 40b are provided in the cathode-side separator 50. However, the first engagement portions 40a, 40b may be provided in the anode-side separator 30. In this case, the anode-side separator 30 corresponds to the first separator, and the cathode-side separator 50 corresponds to the second separator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising:
a stack main body that includes stacked single cells, each single cell including a power generating unit, a first separator, and a second separator, the first separator and the second separator holding the power generating unit in between; and
sensing terminals made of metal, each sensing terminal being inserted into a space between the first separator of a corresponding one of the single cells, and the second separator of another single cell that is adjacent to the corresponding single cell, from outside the single cells, wherein
two surfaces facing each other in any adjacent two of the single cells are respectively defined as a first facing surface and a second facing surface, the first facing surface being a surface of the first separator of one of the two single cells, and the second facing surface being a surface of the second separator of the other single cell,
the first facing surface is provided with at least one first engagement portion,
each sensing terminal includes:
a base portion that contacts the first facing surface of the corresponding first separator;
an arm portion that protrudes from the base portion toward the second facing surface of the corresponding second separator and extends toward a trailing side in an insertion direction of the sensing terminal; and
at least one second engagement portion that is engaged with the at least one first engagement portion of the first facing surface by means of a recess-and-projection relationship to prevent the sensing terminal from coming off the stack main body, and
the arm portion is in contact with the second facing surface while being elastically deformed toward the first facing surface.

2. The fuel cell stack according to claim 1, wherein the at least one first engagement portion protrudes toward the second facing surface.

3. The fuel cell stack according to claim 1, wherein
the at least one first engagement portion includes first engagement portions that are spaced apart from each other in the insertion direction, and
the at least one second engagement portion includes second engagement portions that are provided to respectively correspond to the first engagement portions.

4. The fuel cell stack according to claim 1, wherein the base portion and the arm portion protrude outward from the single cells.

5. The fuel cell stack according to claim 1, wherein
a direction in which the single cells are stacked is defined as a stacking direction,
each single cell further includes a sheet member that has an electrical insulation property, the sheet member being provided between the first separator and the second separator and surrounding the power generating unit,
the sensing terminals include sensing terminals that are provided on opposite sides in the stacking direction of a corresponding one of the single cells, the sensing terminals each having a protruding portion that protrudes outward from edges of the first separator and the second separator, and
the sheet member of the corresponding single cell includes a cover portion that covers the protruding portion in the stacking direction.

6. The fuel cell stack according to claim 5, wherein the protruding portion is provided with a mark at a position of a protruding end of the cover portion in the insertion direction, the mark indicating that the sensing terminal has been inserted to a proper position.

7. The fuel cell stack according to claim 6, wherein the mark is a protruding end of the protruding portion.

8. A sensing terminal made of metal, the sensing terminal being configured to be used for a fuel cell stack, wherein
the fuel cell stack includes a stack main body that includes stacked single cells,
each single cell includes a power generating unit, a first separator, and a second separator,
the first separator and the second separator hold the power generating unit in between,
the sensing terminal is configured to be inserted into a space between the first separator of a corresponding one of the single cells, and the second separator of another single cell that is adjacent to the corresponding single cell, from outside the single cells,
two surfaces facing each other in any adjacent two of the single cells are respectively defined as a first facing surface and a second facing surface, the first facing surface being a surface of the first separator of one of the two single cells, and the second facing surface being a surface of the second separator of the other single cell,
the sensing terminal comprises:
a base portion that contacts the first facing surface of the corresponding first separator;
an arm portion that protrudes from the base portion toward the second facing surface of the corresponding second separator and extends toward a trailing side in an insertion direction of the sensing terminal; and
a received portion that is engaged with a receiving portion provided in the first facing surface by means of a recess-and-projection relationship to prevent the sensing terminal from coming off the stack main body, and
the arm portion is in contact with the second facing surface while being elastically deformed toward the first facing surface.
